(19) United States
(12) Patent Application Publication
(10) Pub. No.: US 2023/0266110 A1
(43) Pub. Date: Aug. 24, 2023

(54) ADHESIVE TEMPLATED MEASUREMENT TAPE

(71) Applicant: Constantinos Hatzopoulos, Los Angeles, CA (US)

(72) Inventor: Constantinos Hatzopoulos, Los Angeles, CA (US)

(21) Appl. No.: 17/823,421

(22) Filed: Aug. 30, 2022

Related U.S. Application Data
(60) Provisional application No. 63/238,925, filed on Aug. 31, 2021.

(51) Int. Cl. G01B 3/1003; G01B 3/00

(52) U.S. Cl. CPC G01B 3/1004; G01B 3/006

(57) ABSTRACT

A device, system and method of augmenting measure units, symbols and patterns upon various surfaces. These surfaces are convenient for such types of measurement applications such as, but not limited to, construction tape, work desks, and locations of building code consideration and placement within innovative areas such as internal paneling. The augmented measuring system can use a repeating pattern to improve referenceability and application.

### RELATED APPLICATIONS

This application claims the benefit of priority to U.S. Provisional Application No. 63/238,925 entitled “ADHESIVE TEMPLATED MEASUREMENT TAPE” filed Aug. 31, 2021, the entire contents of which are hereby incorporated by reference.

### TECHNICAL FIELD

The present disclosure relates to the field of hand tools. Specifically, the present invention relates to an adhesive measuring tape possessing several improvements such as providing templaced measurement indicia to identify construction features and components.

### BACKGROUND

Measuring tools and instruments available today are limited in their application in identifying specific locations and measurements of hidden construction features. These restrictions often make it difficult to effectively and adequately perform home renovations, repairs, and construction of new buildings, as it can be difficult to identify exact placements and measurements.

Prior techniques and devices used in such scenarios fail for various reasons such as consisting of insubstantial and vulnerable materials, methods of use that are susceptible to issues during regular mechanical and physical occurrences, and/or the devices themselves have limited capabilities due to their design. This invention resolves the issue that difficult measurement scenarios present in a novel and innovative manner. This innovative manner will free the hands of the user and allow more effective usage of the user's time and resources.

### SUMMARY

Aspects and advantages of the invention will be set forth in part in the following description, or may be obvious from the description, or may be learned through practice of the invention.

In general, one innovative aspect of the subject matter described in this specification can be embodied as a material wherein a measurement indica is embedded in at least one surface and viable.

In some embodiments, the material includes an external surface wherein the external surface displays measurement markings.

In some embodiments, the material includes an external surface wherein the external surface displays measurement markings, wherein the material is relatively flat.

In some embodiments, the material includes an external surface wherein the external surface displays measurement markings, wherein the material is tape.

In some embodiments, the material includes an external surface wherein the external surface displays measurement markings, wherein the material is construction tape.

In some embodiments, the material includes an external surface wherein the external surface displays measurement markings, wherein the measurement markings are based in the metric system.

In some embodiments, the material includes an external surface wherein the external surface displays measurement markings, wherein the measurement markings are based on the US imperial system.

In some embodiments, the material includes an external surface wherein the external surface displays measurement markings, wherein the distance between measurement markings are based on a specific building code distance.

In some embodiments, the material includes an external surface wherein the external surface displays measurement markings, wherein the measurement markings comprises of a repeating center mark.

In some embodiments, the material includes an external surface wherein the external surface displays measurement markings, wherein the measurement markings comprises of a repeating series of a center mark and a plurality of secondary marks, wherein the pattern, order and distance of the center mark and the secondary marks identically matches the next series and is positioned on all of the external surface.

In some embodiments, the material includes an external surface wherein the external surface displays measurement markings, wherein the external surface also possesses adhesive properties.

In some embodiments, the invention is a piece of furniture comprising of a top surface wherein at least a portion of the top surface displays a measurement system.

In some embodiments, the invention is a piece of furniture comprising of a top surface where in at least a portion of the top surface displays a measurement system, wherein the measurements and comprises of a series of center marks.

In some embodiments, the invention is a piece of furniture comprising of a top surface wherein at least a portion of the top surface displays a measurement system, wherein in the furniture is a desk.

In some embodiments, the invention is a piece of furniture comprising of a top surface wherein at least a portion of the top surface displays a measurement system, wherein in the furniture is a work desk.

In some embodiments, the invention is a method of providing an augmented measuring surface comprising of providing the measurement system and disposing a measurement system on an external surface.

In some embodiments, the invention is a method of determining internal building features locations comprising of providing a material comprising of an adhesive surface and an external surface wherein the external surface displays measurement markings based on a building code, and a building governed by the building codes, wherein the material is placed at specific points in the building that correspond with the building code.

### BRIEF DESCRIPTION OF THE FIGURES

A full and enabling disclosure of the present invention, including the best mode thereof, directed to one of ordinary skill in the art, is set forth in the specification, which makes reference to the appended drawings in, which:

FIG. 1 is a top-center perspective view of an embodiment wherein the material 10 is embodied as tape 15, wherein the tape 15 includes an external surface 30, a measurement marking system 40, a plurality of center mark 50 and a plurality of secondary markings 60, and a repeating series 70 comprising of the center marks 50 and secondary marks 60 are shown;

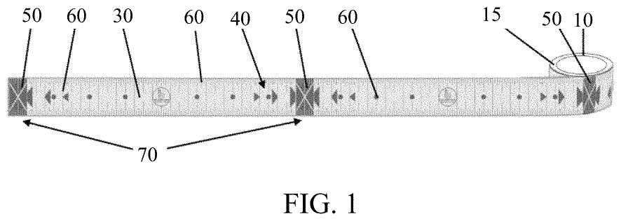

FIG. 2 is a front, right, top perspective view of an exemplary embodiment of the material 10, wherein the material is embodied as an augmented measuring surface 110 on the top surface of a desk 80 are shown;

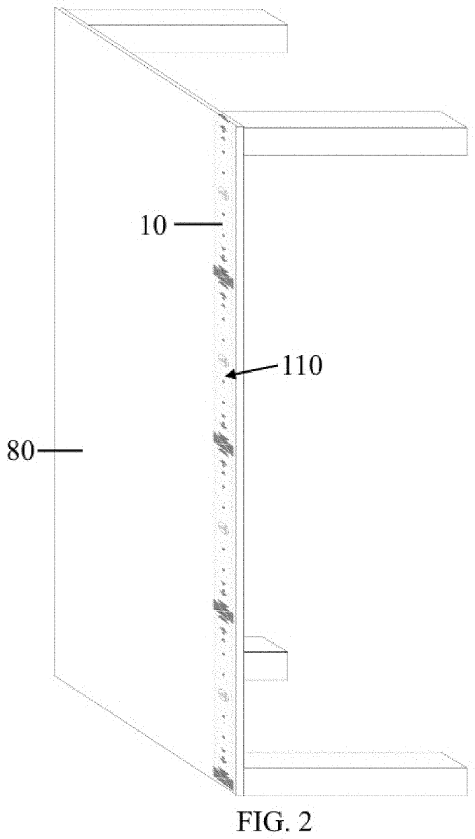

FIG. 3 is a front, left, top perspective view of an exemplary embodiment of the material 10 as tape 15, wherein the external surface 30, measurement marking system 40, center mark 50 and secondary markings 60, and the repeating series 70 are shown, wherein the repeating series 70 is designed to match up precisely with the standard distance 100 of a specific building code 100 are shown;

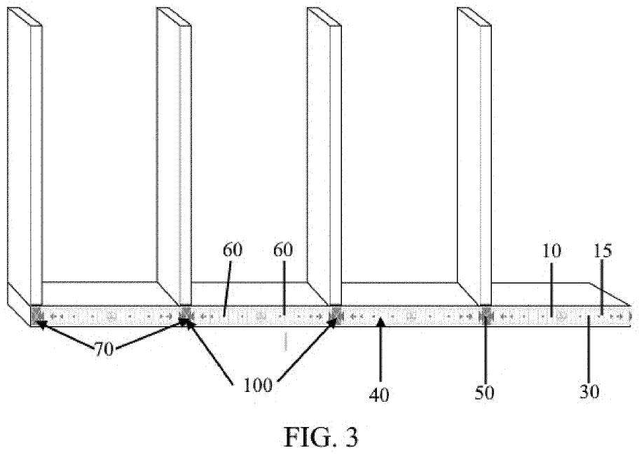

FIG. 4 is a top view and bottom view of several embodiments of the material 10 as tape 15, wherein the adhesive side 20, the external surface 30, measurement marking system 40, center mark 50 and secondary markings 60, and the repeating series 70 are shown;

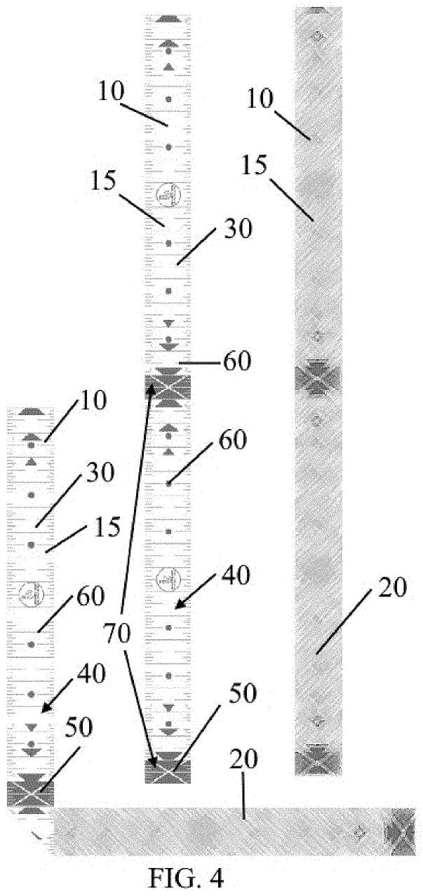

Repeat use of reference characters in the present specification and drawings is intended to represent the same or analogous features or elements of the present invention.

### DETAILED DESCRIPTION

Reference now will be made in detail to the embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

In accordance with the present invention, a building device or material 10 that assists with measuring surfaces. The material 10 has a measurement indicia in various forms or embodiments that provides the user an immediate understanding of relative distances and portions of the surface and/or object the measurement indicia is being placed upon. The measurement indicia is disposed on a section of the material 10 so wherein upon placement of the material 10 the measurement indicia is visible. If the material 10 has multiple sides, then the side that the measurement indicia is placed upon is identified as the external surface 30 for the purposes of this application. The terms measurement indicia and measurement marking system 40 are used interchangeably.

The measurement indicia is optimal when integrated into a material 10 with a sufficient surface area visible upon placement or external surface 30. In many embodiments, the material 10 is presented in forms wherein the material 10 is overall relatively flat or the material 10 has at least one surface area that is relatively flat. Furthermore, in many of these embodiments the material 10 is presented in forms wherein the material 10 is overall relatively flat or the material 10 has at least one surface area that is relatively flat. For example, in some embodiments the material 10 is made of a paper-similar material.

The material 10 can be in many forms or embodiments. For example the material 10 can be in the form of tape 15, construction tape, and other adhesion-placement products. In these embodiments, the external surface 30 is on the surface that is opposite in position to that of the adhesive surface 20 and the measurement indicia or measurement marking system 40 are disposed on or integrated into the external surface 30 of the material 10. In embodiments wherein the adhesion-placement product has two adhesive surfaces or is otherwise “double-sided” then the external surface 30 and the measurement marking system 40 will be integrated into one of the two adhesive surfaces and the opposite side will continue to be identified as the adhesive surface 20 for purposes of this application.

The measurement indicia can be in many forms. It can be in the form of a measurement system 40. The measurement indicia can be in the form of augmented measuring surface 110 where in the augmented measuring surface 110 is disposed on the surface of interest or consideration. In some embodiments, the augmented measuring surface 110 may be transmitted by lights or lasers onto a surface. In other embodiments, the augmented measuring surface 110 is etched, engraved or otherwise inputted an external surface 30.

The content of the measurement system 40 itself varies greatly depending on the embodiments. In some embodiments the measurement system utilizes a repeating series 70 wherein the repeating series 70 includes a center mark 50 and secondary marks 60. When referring to the secondary marks 60, a single mark or symbol can be used or a plurality of symbols and marks can be used. For example, in some embodiments of the invention the measurement system 40 may include only one type of secondary mark 60. In some embodiments of the invention multiple different types of secondary mark 60 are incorporated into the measurement system 40.

In some embodiments of the invention, the measurement system 40 utilizes marks and symbols including, but not limited to, center marks 50 and secondary marks 60 wherein the position of these marks and symbols is based on units of the Imperial System (IS) of measurement. In some embodiments the measurement system 40 utilizes marks and symbols including, but not limited to, center marks 50 and secondary marks 60 wherein the position of these marks and symbols is based on units of the Metric System. In some embodiments the measurement system 40 utilizes marks and symbols including, but not limited to, center marks 50 and secondary marks 60 wherein the position of these marks and symbols is based on both units of the Imperial System (IS) of measurement and units the Metric System. In one non-limiting and illustrative example, the distance between the center marks 50 is exactly one inch and the distance between the secondary marks correspondence with a consistent portion of an inch such as one thirty-second, one sixteenth, one eighth, one fourth, one half, seventeen thirty-seconds, and so on. In another non limiting example, the distance between the center marks 50 is exactly one centimeter and the distance between the secondary marks 60 corresponds to one millimeter. In another non limiting example, the distance between the center marks 50 is exactly five centimeters and the distance between the secondary marks 60 corresponds to one centimeter, ten millimeters, and one millimeter depending on the secondary mark 60.

In some embodiments of the invention, the measurement system 40 is based on a specific building code distance. These building code distances can be the building codes provided from or adopted by various government agencies including Department of Housing and Community Development (HCD), Office of the State Fire Marshal (SFM), Division of the State Architect (DSA), Office of Statewide Health Planning and Development (OSHPD), The California Department of Public Health (CDPH), Department of Consumer Affairs (DCA), California Energy Commission (CEC), State Historical Building Safety Board (SHBSB), California Department of Food and Agriculture (CDFA), Department of Water Resources (DWR), Board of State and Community Corrections (BSCC), California State Library (CSL), and/or the State Lands Commission (SLC). The adoption and incorporation of the building codes will provide numerous advantages and applications. When the present invention as a device, system or method is properly positioned on a wall based on a known reference point or feature, the user will be able to identify various construction features of the building such as the stud locations to assist with the performance of a specific project.

In some embodiments of the invention, the invention provides methods of determining internal features of a building by an embodiment of the invention that has a measurement system 40 based on the building code that governs or applies to the building. During these methods, the measurement system 40 is lined up with any various features and/or distances of the building that correspond to a building code such as, but not limited to, height, distance from an access point of a certain feature, and so on. As the measurement system 40 is correctly positioned in relation to the feature, the other points on the measurement system 40 will identify locations of latent features behind the wall such as, but not limited to, studs, wiring and so on. These methods will require different measurement systems 40 for different building codes and thereby require a plurality of embodiments of the invention.

In some embodiments of the invention, the measurement system 40 can be described as a repeating series 70 of center marks 50 and secondary marks 60, wherein between the center marks 50 the secondary marks 60 follow a repeating pattern wherein the position of a secondary mark 60 determines which symbol is used to identify said secondary mark 60. In embodiments of the invention wherein a repeating series 70 is incorporated, the invention allows flexible and variable positioning of the measurement system 40 to any external surface 30. In some embodiments, the repeating region 70 corresponds to a specific distance defined by a set unit or distance of the Imperial System (IS) of measurement such as, but not limited to, an inch, a set amount of inches, a yard or a set amount of yards. In some embodiments, the repeating region 70 corresponds to a specific distance defined by a set unit or distance of the metric system such as, but not limited to, a millimeter, a set amount of millimeters, a centimeter, a set amount of centimeters, a set amount of meters or a meter.

In some embodiments of the invention, the material 10 is embodied as, or incorporated into, a piece of furniture. In some embodiments of the invention, the material 10 is embodied as, or incorporated into, a piece of furniture, wherein the furniture 75 is a desk 80. In some embodiments of the invention, the material 10 is embodied as, or incorporated into, a piece of furniture 75, wherein the furniture is a work desk 85.

The invention has special applications with irregular surfaces and irregular object shapes such as cylinder or rod shapes. In some embodiments of the invention, the material 10 wraps around an object of interest such as a pipe, wooden support, or similar object allowing accurate circumference measurements and other surface measurements on irregular surfaces. When the material 10 wraps around or ecompasses an object, it allows measurement and reference on different sides of said object.

The present invention also discloses a method of providing a measurement system 40 to an external surface 30. The method includes defining a measurement system 40 and disposing of the measurement system 40 to an external surface 30. The measurement system 40 can be disposed on an external surface 30 using lasers, engraving or a secondary material such as tape. The measurement system 40 can further be disposed on an external surface 30 by various light systems. The measurement system 40 can further be disposed on an external surface 30 by various augmentation methods. The measurement system 40 can further be disposed on an external surface 30 in the form of augmented reality.

The present invention, previously described as a device and method, can be incorporated into a system wherein the material 10 is the entire system or a part of a larger system.

All elements of all embodiments, as previously specified and/or unspecified, of the present invention are easily and capably produced through various manufacturing techniques. All elements of all embodiments, as previously specified and/or unspecified, of the present invention can be manufactured at various lengths, widths, heights, thicknesses, weights, designs, shapes, sizes, colors, and other various features and characteristics. The present invention can be manufactured from various types of materials and compositions, including various metals and/or metal alloys, various plastics and/or plastic compositions, various woods, and/or other various organic and/or inorganic compounds and materials. However, the present invention may also utilize various types of materials, components, methods, designs, and patterns to achieve the desired result and function.

The invention can be applied in other industries as well. The invention has specific and effective applications in the industries of crafting, sewing, and baking.

What is claimed is:

1. A material comprising of an adhesive surface and an external surface wherein the external surface displays measurement markings.

2. The material in claim 1 wherein the material is relatively flat.

3. The material in claim 1 wherein the material is tape.

4. The material in claim 1 wherein the material is construction tape.

5. The material in claim 1 wherein the measurement markings are based in the metric system.

6. The material in claim 1 wherein the measurement markings are based on the US imperial system.

7. The material in claim 1 wherein the distance between measurement markings are based on a specific building code distance.

8. The material in claim 1 wherein the measurement markings comprises of a repeating center mark.

9. The material in claim 1 wherein the measurement markings comprises of a repeating series of a center mark and a plurality of secondary marks, wherein the pattern, order and distance of the center mark and the secondary marks identically matches the next series and is positioned on all of the external surface.

10. The material in claim 1, wherein the external surface also possesses adhesive properties.

11. A piece of furniture comprising of a top surface wherein at least a portion of the top surface displays a measurement system.

12. The piece of furniture of claim 11, wherein the measurement system comprises of a series of center marks.

13. The furniture of claim 12, wherein the furniture is a desk.

14. A method of providing an augmented measuring surface comprising of providing a measurement system and disposing the measurement system on an external surface.

15. A method of determining the locations of internal building features comprising of providing a material comprising of an adhesive surface and an external surface wherein the external surface displays measurement markings based on a building code, and a building governed by the building codes, wherein the material is placed at specific points in the building that correspond with the building code.
